(19) United States
(12) Patent Application Publication
(10) Pub. No.: US 2026/0116603 A1
(43) Pub. Date: Apr. 30, 2026

(54) FOLDING APPARATUS AND SEALING APPARATUS

(71) Applicant: ISHIDA CO., LTD., Kyoto-shi (JP)

(72) Inventors: Tatsuya IWASA, Shiga (JP); Yoshinobu SHIMOMAE, Shiga (JP); Tatsuya ARIMATSU, Shiga (JP); Yuji YOKOTA, Shiga (JP)

(21) Appl. No.: 19/368,656

(22) Filed: Oct. 24, 2025

(30) Foreign Application Priority Data
Oct. 28, 2024 (JP) 2024-189280

(51) Int. Cl. B65B 43/10; B65B 7/20; B65B 43/26

(52) U.S. Cl. CPC B65B 43/10; B65B 7/20; B65B 43/265

(57) ABSTRACT

A folding apparatus includes: a transport unit; and a folding unit disposed above the transport unit and configured to fold a front flap and a rear flap into the inside of an opening of a cardboard box. The transport unit stops transport of the cardboard box when the cardboard box is positioned below the folding unit. The folding unit includes a first abutting portion and a second abutting portion, a first mechanism configured to drive the first abutting portion and the second abutting portion and make the front flap and the rear flap stand upright from below in conjunction with an operation of the first abutting portion and the second abutting portion, and a second mechanism configured to fold the front flap and the rear flap standing upright toward the inside of the opening by moving the first abutting portion and the second abutting portion along a transport direction.

### CROSS REFERENCE TO RELATED APPLICATIONS

This application claims the benefit of priority to Japanese Patent Application Number 2024-189280 filed on October 28, 2024. The entire contents of the above-identified application are hereby incorporated by reference.

### TECHNICAL FIELD

The present disclosure relates to a folding apparatus and a box sealing apparatus.

### BACKGROUND

In JP 2019-147583 A, a box sealing apparatus is disclosed that closes flaps provided at edges of an opening of a cardboard box while transporting the cardboard box. The box sealing apparatus includes a flap folding unit that abuts against a first flap, which is a flap provided on the front side of the cardboard box in its transport direction, so as to fold the first flap, and a side surface pressing portion that presses a side surface of the cardboard box, which is being transported, when the flap folding unit folds the first flap. Immediately before the flap folding unit abuts against the first flap from the front side, the side surface pressing portion presses the side surface of the cardboard box, and when the first flap is folded toward the rear side, the side surface pressing portion separates from the side surface of the cardboard box.

### SUMMARY

As in the known device described above, when the configuration is adopted in which the flap is folded while the cardboard box is transported, it is necessary to secure a transport distance (length of a conveyor or the like) in a transport unit that transports the cardboard box. Therefore, a space for disposing the transport unit is required, and an increase in the size of the device cannot be avoided.

An object of an aspect of the present disclosure is to provide a folding apparatus and a box sealing apparatus that can achieve space savings.

(1) A folding apparatus according to an aspect of the present disclosure includes: a transport unit configured to transport a cardboard box in a transport direction that is substantially horizontal; and a folding unit disposed above the transport unit, the folding unit being configured to fold, among a plurality of flaps provided at an edge of an opening of the cardboard box, a pair of the flaps into an inside of the opening of the cardboard box, the pair of the flaps extending in a direction intersecting the transport direction in a horizontal direction, in which the transport unit stops transport of the cardboard box when the cardboard box is positioned below the folding unit, and the folding unit includes a first abutting portion configured to abut against one of the pair of the flaps, and a second abutting portion configured to abut against another of the pair of the flaps, a first mechanism configured to drive the first abutting portion and the second abutting portion and make the pair of the flaps stand upright from below respectively in conjunction with an operation of the first abutting portion and the second abutting portion, and a second mechanism configured to fold the pair of the flaps standing upright toward an inside of the opening by moving the first abutting portion and the second abutting portion along the transport direction.

In the folding apparatus according an aspect of the present disclosure, when the cardboard box is positioned below the folding unit, the transport unit stops the transport of the cardboard box. In this configuration, the first mechanism of the folding unit drives the first abutting portion and the second abutting portion and makes the pair of the flaps stand upright from below respectively in conjunction with the operation of the first abutting portion and the second abutting portion, and the second mechanism folds the pair of the flaps standing upright into the inside of the opening by moving the first abutting portion and the second abutting portion in a direction in which the first abutting portion and the second abutting portion approach each other. In this way, the folding apparatus can fold the flaps in a state in which the cardboard box is stopped. Therefore, the folding apparatus can achieve space savings.

(2) In the folding apparatus according to (1) described above, the transport unit may include a lifting mechanism configured to raise and lower the cardboard box in a vertical direction, and the lifting mechanism may bring the cardboard box closer to the folding unit by raising the cardboard box. In this configuration, in addition to folding the pair of the flaps using the second mechanism, by bringing the cardboard box closer to the first abutting portion and the second abutting portion using the lifting mechanism, the pair of the flaps can be folded more reliably in a short time period.

(3) In the folding apparatus according to (1) or (2) described above, the first abutting portion may be disposed downstream of the second abutting portion in the transport direction of the transport unit, and the folding unit may position the first abutting portion above the second abutting portion when the transport unit transports the cardboard box after the pair of the flaps are folded. In this configuration, when the cardboard box is transported (discharged) by the transport unit, it is possible to prevent the first abutting portion from coming into contact with the flap.

(4) The folding apparatus according to any one of (1) to (3) described above, in each of the first abutting portion and the second abutting portion, a convex portion protruding downward may be provided on a tip end side of an abutting section that abuts against a corresponding one of the flaps upon folding the corresponding flap during movement of the first abutting portion and the second abutting portion by the second mechanism. In this configuration, the flap can be folded more deeply (further to a lower position) by the convex portion.

(5) A box sealing apparatus according to an aspect of the present disclosure includes: the folding apparatus according to any one of (1) to (4) described above, and a sealing apparatus configured to seal the flaps of the cardboard box in which the pair of the flaps have been folded by the folding apparatus.

The box sealing apparatus according to an aspect of the present disclosure includes the folding apparatus described above. Therefore, the box sealing apparatus can achieve space savings.

According to an aspect of the present disclosure, space savings can be achieved.

### BRIEF DESCRIPTION OF DRAWINGS

FIG. 1 is a diagram illustrating a boxing system with a box sealing apparatus mounted therein according to an embodiment.

FIG. 2 is a perspective view illustrating a configuration of the boxing system.

FIG. 3 is a perspective view illustrating a flow of a cardboard box and a product in the boxing system.

FIG. 4 is a diagram illustrating a configuration of a folding apparatus.

FIG. 5 is a perspective view illustrating the configuration of the folding apparatus.

FIG. 6 is a perspective view illustrating the configuration of the folding apparatus.

FIG. 7A and 7B are diagrams illustrating an operation of a position adjustment mechanism.

FIG. 8 is a perspective view illustrating a configuration of a folding unit.

FIG. 9 is a diagram for explaining an operation of the folding apparatus.

FIG. 10 is a diagram for explaining the operation of the folding apparatus.

FIG. 11 is a diagram for explaining the operation of the folding apparatus.

FIG. 12 is a diagram illustrating regions formed by flaps.

FIG. 13 is a diagram illustrating a positional relationship between an abutting portion and the cardboard box.

FIG. 14 is a diagram for explaining folding of the flap by the abutting portion.

### DESCRIPTION OF EMBODIMENTS

A preferred embodiment of the present disclosure will be described below in detail with reference to the attached drawings. Note that, in the description of the drawings, like or equivalent elements are denoted by the same reference signs and redundant descriptions thereof will be omitted.

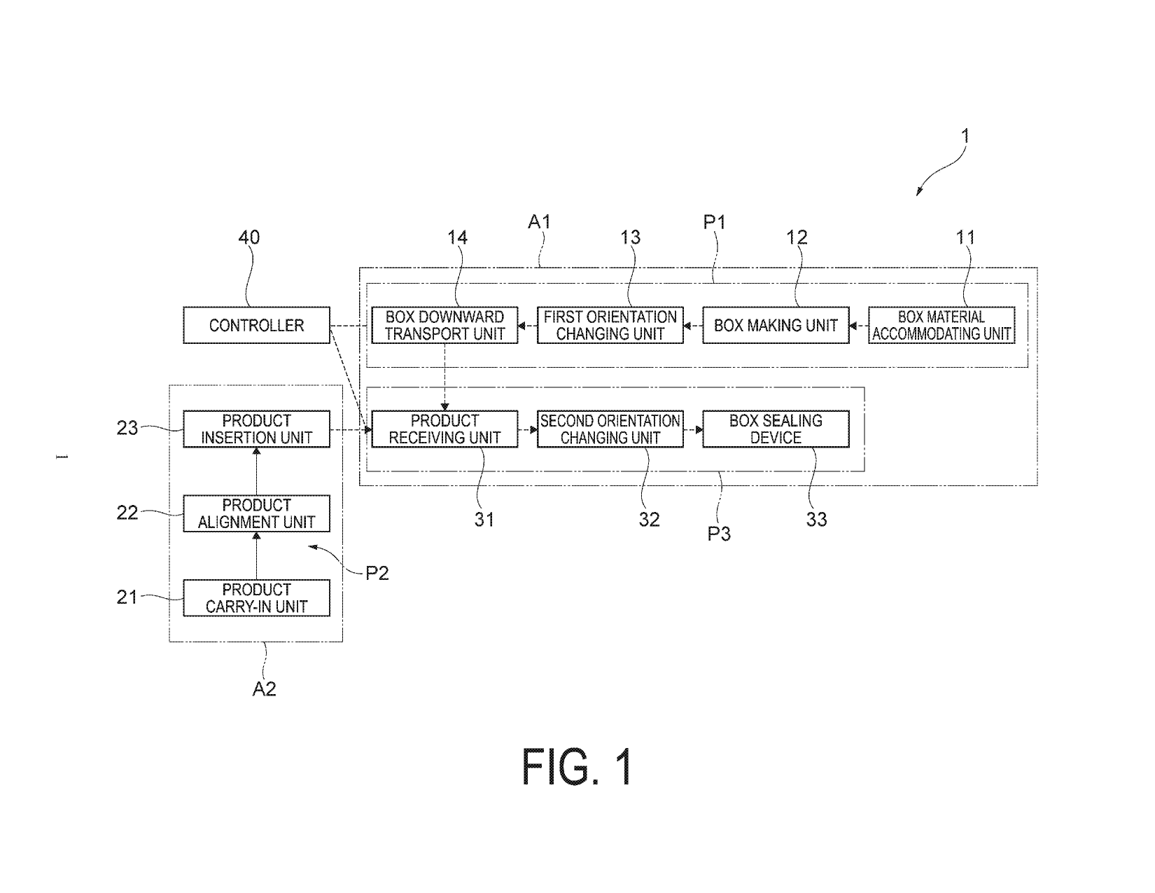

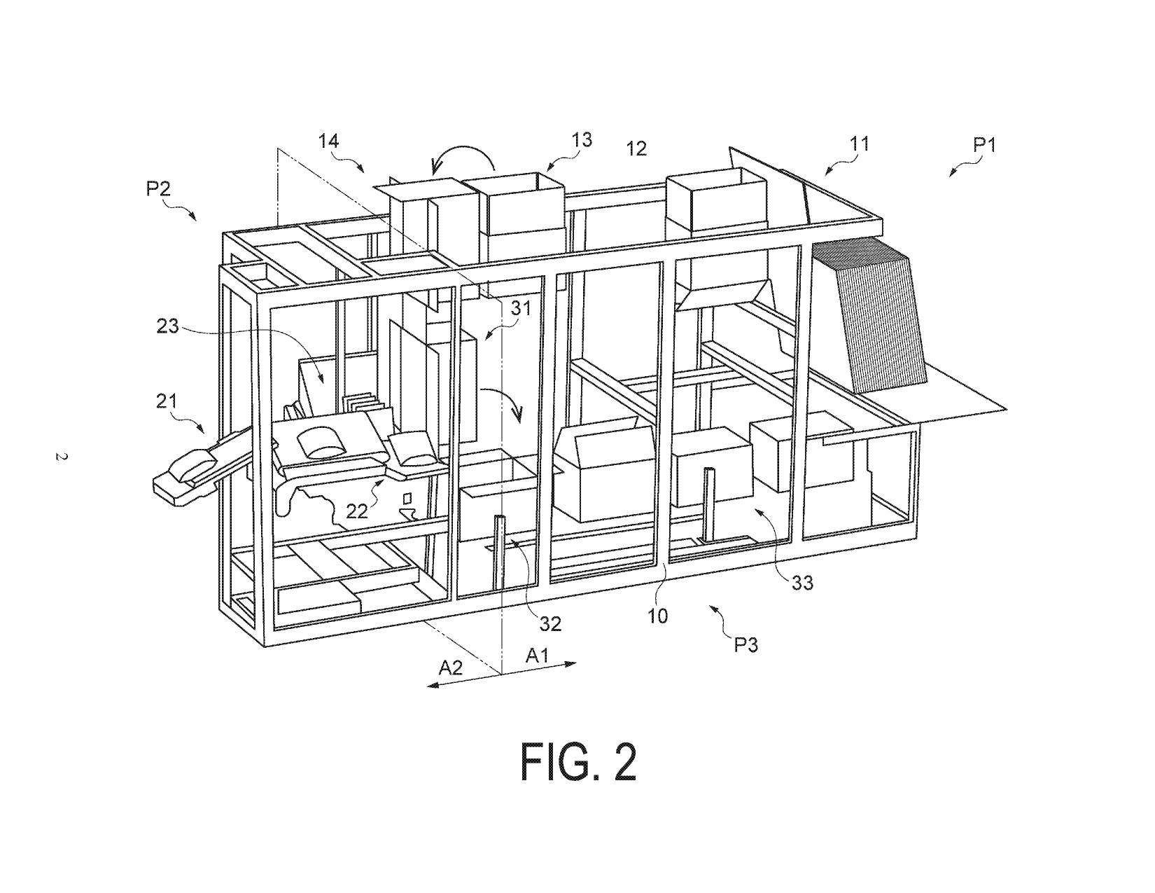

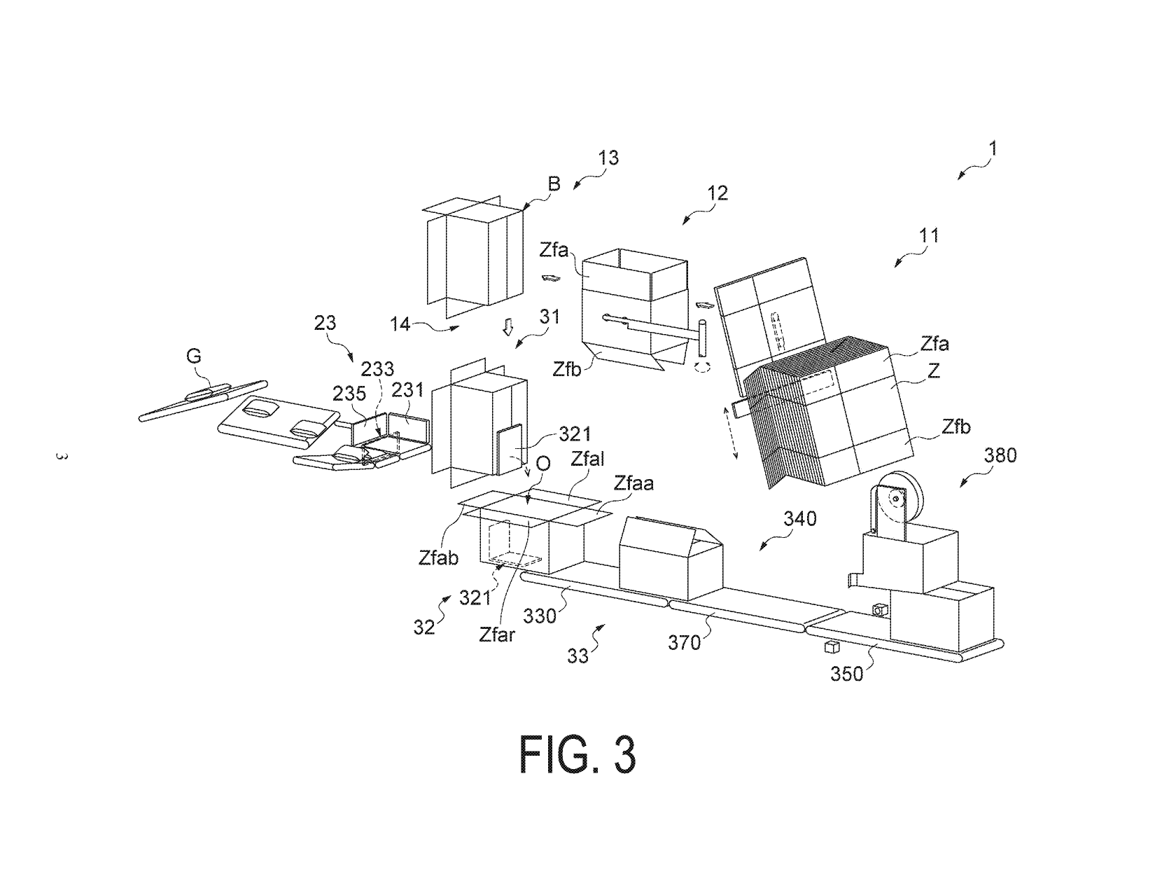

FIG. 1 is a diagram illustrating a configuration of a boxing system with a box sealing apparatus mounted therein according to an embodiment. FIG. 2 is a perspective view illustrating the configuration of the boxing system. FIG. 3 is a perspective view illustrating a flow of a cardboard box and a product in the boxing system.

As illustrated in FIGS. 1 and 2, a boxing system 1 packs a certain number of bagged products (products G) such as snack foods in a cardboard box B in an aligned state in multiple layers.

As illustrated in FIGS. 2 and 3, a cardboard box handling area A1 has a two-story structure, a second-story portion handles a box making process P1, and a first-story portion handles a boxing process P3. In order to have the two-story structure, a transport direction of the cardboard box B from assembly of the cardboard box B in a box making unit 12 to a box downward transport unit 14, and a transport direction of the cardboard box B until an opening O of the cardboard box B packed with the products G is sealed by a box sealing apparatus 33 are opposite to each other.

As illustrated in FIG. 3, the box making process P1 is executed by a box material accommodating unit 11 that introduces a cardboard box material Z into the boxing system 1, the box making unit 12 that assembles the cardboard box B, a first orientation changing unit 13 that rotates the cardboard box B by 90° around a horizontal axis orthogonal to the transport direction of the cardboard box B, and the box downward transport unit 14 that transports the cardboard box B in a first orientation downward.

In the box material accommodating unit 11, the top cardboard box material Z among the cardboard box materials Z stacked at a supply position is gripped and fed upward one by one, and the cardboard box material Z fed upward is rotated 90° around a vertical axis and expanded into a cylindrical shape. The cardboard box materials Z are placed at the supply position by an operator. The cardboard box materials Z are folded with flaps Zf open, and are stacked in the horizontal direction in an orientation in which the flaps Zf are positioned to extend in the vertical direction. Note that, for convenience of description, the flap Zf on the top surface side is referred to as a top flap Zfa, and the flap Zf on the bottom surface side is referred to as a bottom flap Zfb.

The box making unit 12 folds and tapes the bottom flaps Zfb of the cardboard box material Z while transporting the cardboard box material Z expanded into the cylindrical shape in the horizontal direction, so as to assemble the cardboard box B with the top flaps Zfa still open.

The first orientation changing unit 13 rotates the cardboard box B by 90° relative to the transport direction. The first orientation changing unit 13 rotates the cardboard box B by 90° around the horizontal axis orthogonal to the transport direction of the cardboard box B, and changes the orientation of the cardboard box B so that the opening O and the top flaps Zfa of the cardboard box B are on the same vertical plane (hereinafter referred to as a first orientation). When the cardboard box B is in the first orientation, the opening O faces a product handling area A2.

The box downward transport unit 14 transports the cardboard box B in the first orientation downward. That is, the cardboard box B is moved downward while the opening O of the cardboard box B faces the product handling area A2.

A weighing device, a bag making and packaging machine, and the like (not illustrated) are disposed upstream of a product alignment process P2 in the flow of the products G of the boxing system 1. The product alignment process P2 is executed by a product carry-in unit 21 that receives the products G and transports the products G to a predetermined position, a product alignment unit 22 that aligns the products G supplied from the product carry-in unit 21, and a product insertion unit 23 that accumulates and pushes out the aligned products G.

An insertion plate 235 is on standby with its flat surface portion facing the opening O of the cardboard box B. After N products G are brought into a standing state, the insertion plate 235 pushes the N products G toward an opening surface of the cardboard box B, thereby inserting the N products G into the cardboard box B from the opening O toward the bottom of the cardboard box B at once. The insertion plate 235 moves across between a standing conveyor 231 and a pushing plate 233, and moves to the opening surface of the cardboard box B.

The boxing process P3 is executed by a product receiving unit 31 that receives the products G in the cardboard box B, a second orientation changing unit 32 that changes the orientation of the cardboard box B so that the opening O of the cardboard box B faces upward, a folding apparatus 340 that folds the flaps, and the box sealing apparatus 33 that closes the opening O of the cardboard box B while transporting the cardboard box B in which the boxing of the products G has completed.

When the cardboard box B is rotated by 90° by an orientation changing mechanism 321, the cardboard box B is placed on a first conveyor 330 with the opening O facing upward. The first conveyor 330 transports the cardboard box B to the folding apparatus 340.

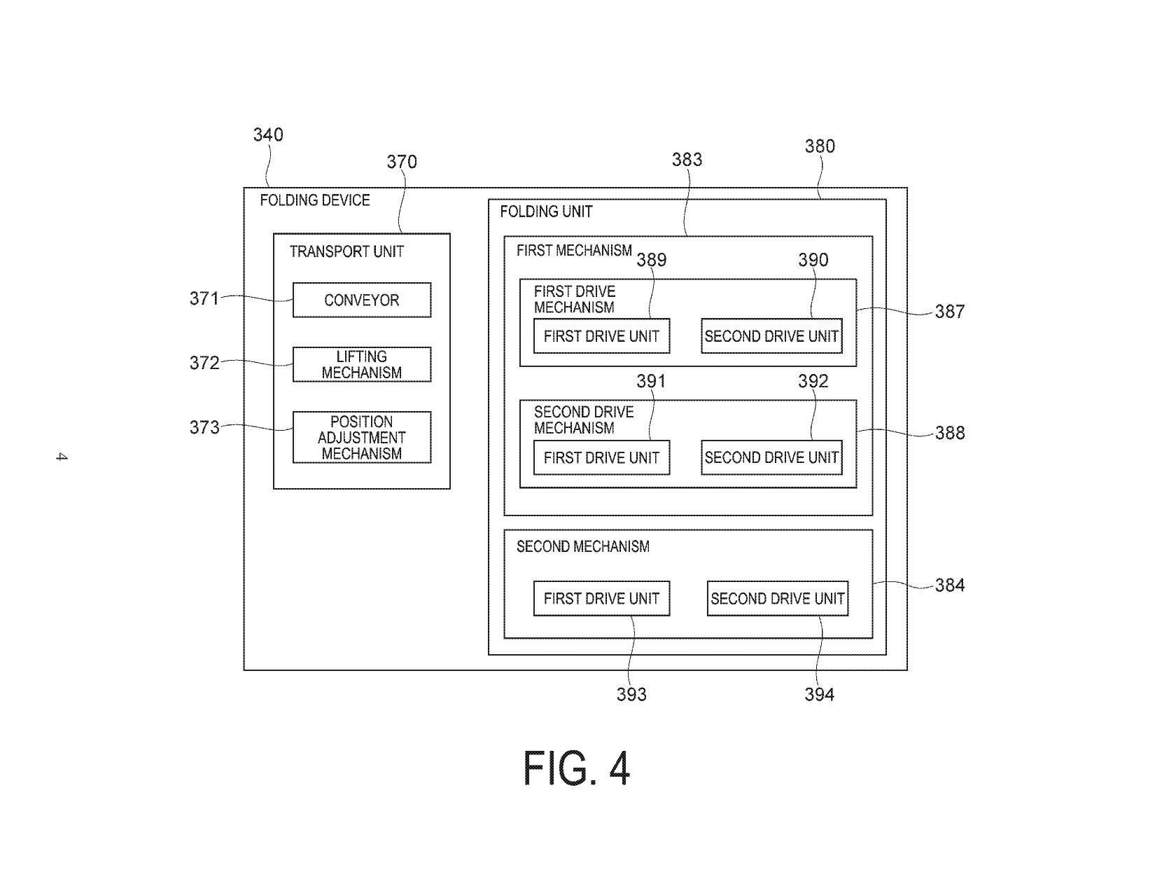

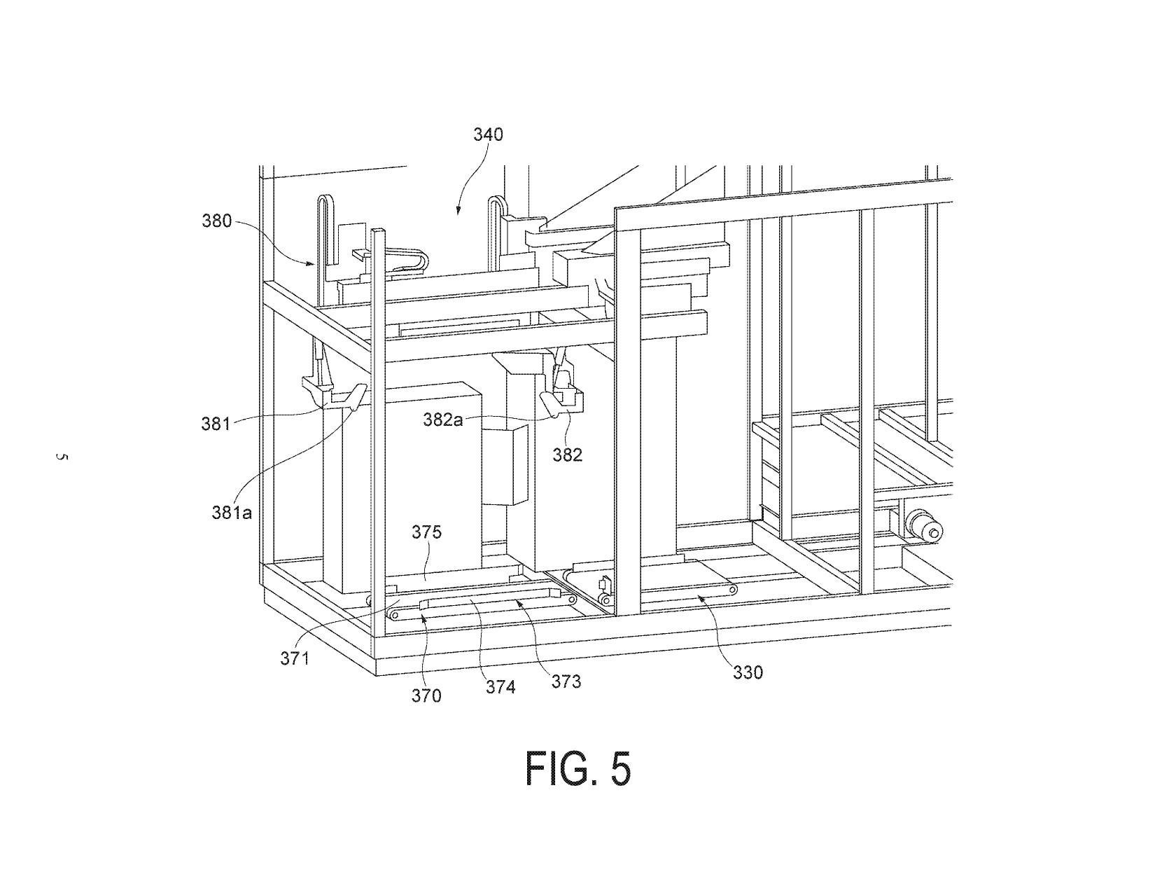

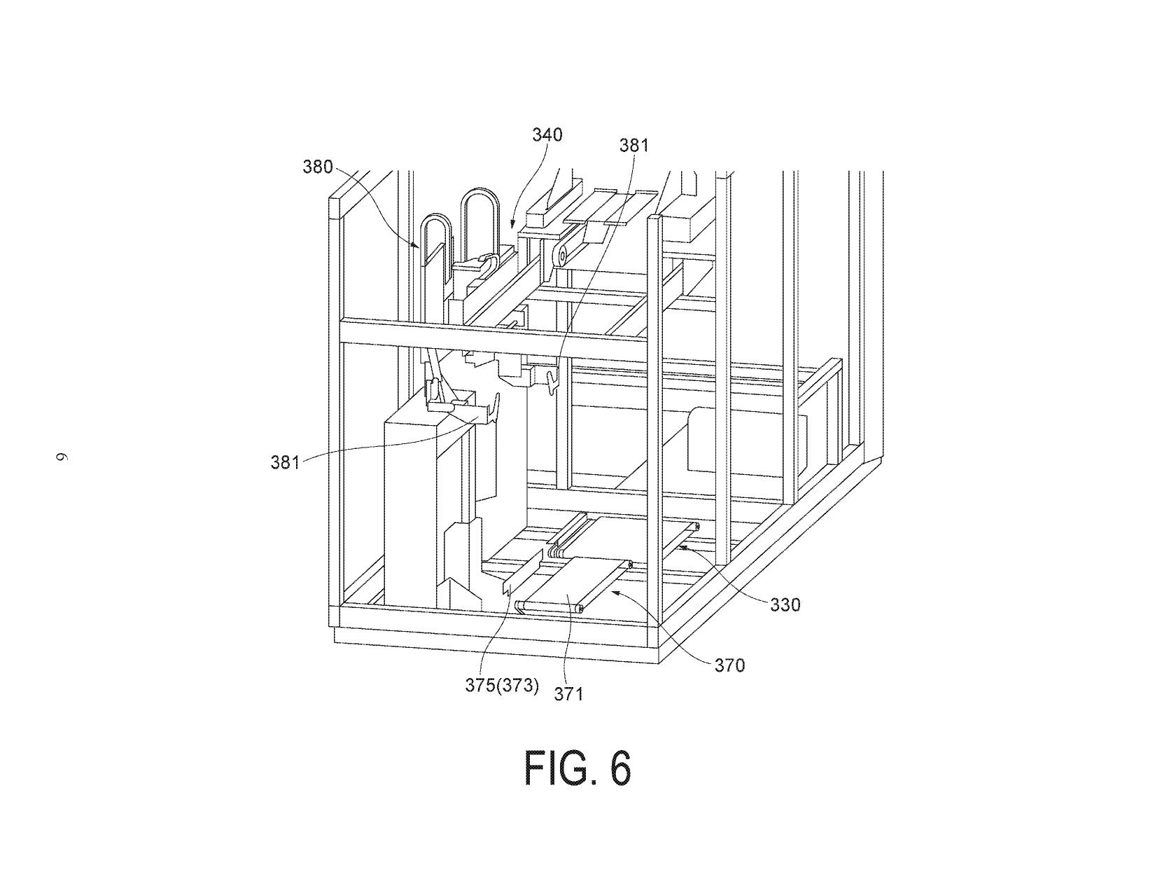

FIG. 4 is a diagram illustrating a configuration of the folding apparatus 340. FIGS. 5 and 6 are perspective views illustrating the configuration of the folding apparatus 340. As illustrated in FIGS. 4 to 6, the folding apparatus 340 includes a transport unit 370 and a folding unit 380.

The transport unit 370 transports the cardboard box B in the transport direction that is substantially horizontal. The transport unit 370 includes a conveyor 371, a lifting mechanism 372, and a position adjustment mechanism 373.

The conveyor 371 transports the cardboard box B. The conveyor 371 receives and transports the cardboard box B carried out from the first conveyor 330. The conveyor 371 transports the cardboard box B to a second conveyor 350. The conveyor 371 is disposed below the folding unit 380. When the cardboard box B is positioned below the folding unit 380, the conveyor 371 stops the transport of the cardboard box B. When the cardboard box B before being carried into the conveyor 371 is detected by a detection sensor (not illustrated), the conveyor 371 stops the transport of the cardboard box B based on the detection result. As a result, the cardboard box B is positioned at a prescribed position in the transport direction of the conveyor 371.

The lifting mechanism 372 raises and lowers the conveyor 371 (cardboard box B) in the vertical direction. The lifting mechanism 372 brings the cardboard box B closer to the folding unit 380 by raising the conveyor 371. The lifting mechanism 372 includes, for example, a ball screw and a motor.

The position adjustment mechanism 373 adjusts the position of the cardboard box B on the conveyor 371. The position adjustment mechanism 373 moves the cardboard box B in a direction orthogonal to the transport direction in the horizontal direction (the width direction of the conveyor 371), and positions the cardboard box B at the prescribed position. The position adjustment mechanism 373 operates when the transport of the cardboard box B is stopped on the conveyor 371.

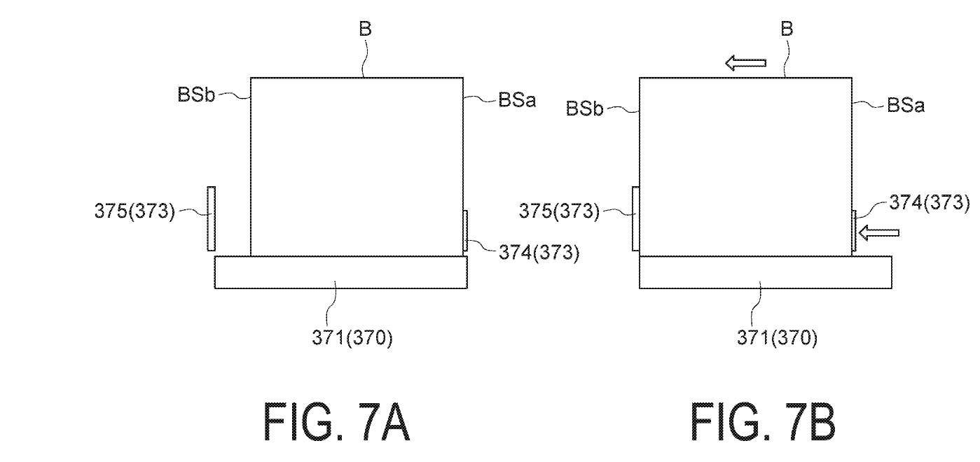

FIGS. 7A and 7B are diagrams illustrating an operation of the position adjustment mechanism 373. As illustrated in FIGS. 7A and 7B, the position adjustment mechanism 373 moves an abutting plate 374 that abuts against a side surface BSa of the cardboard box B in a direction approaching a regulation plate 375 (a direction in which the distance between the abutting plate 374 and the regulation plate 375 is reduced), and moves the cardboard box B until a side surface BSb of the cardboard box B abuts against the regulation plate 375. As a result, the cardboard box B is positioned at the prescribed position in the direction orthogonal to the transport direction of the conveyor 371 in the horizontal direction (the width direction of the conveyor 371).

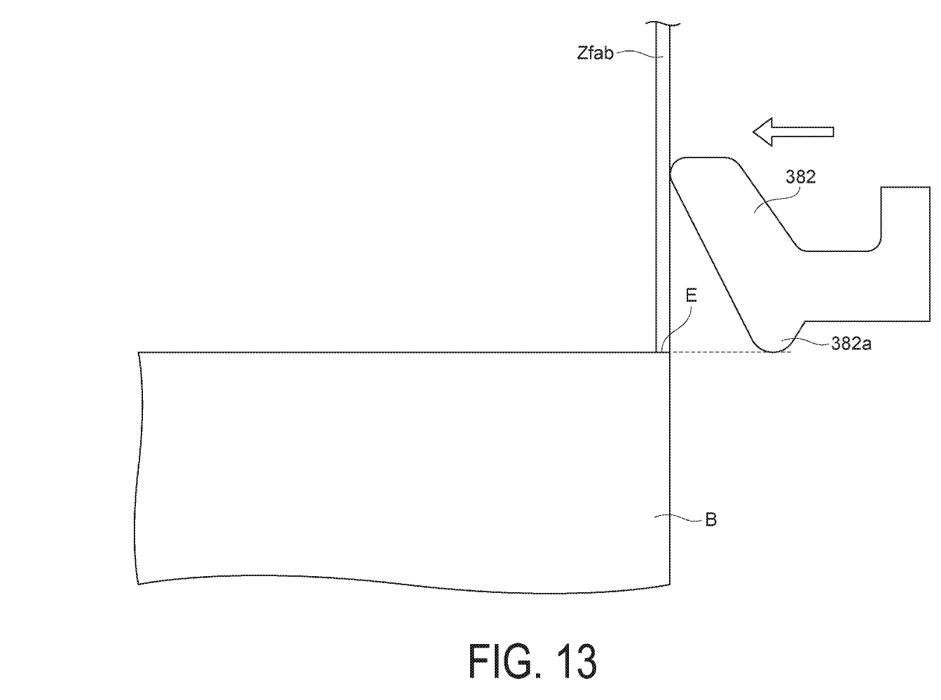

The folding unit 380 is disposed above the transport unit 370 (conveyor 371). The folding unit 380 folds, among a front flap (one flap) Zfaa, a rear flap (the other flap) Zfab, a left flap Zfal, and a right flap Zfar provided at an edge E (see FIG. 13) of the opening O of the cardboard box B, the front flap Zfaa and the rear flap Zfab (a pair of flaps) extending in a direction intersecting the transport direction of the conveyor 371 in the horizontal direction into the inside of the opening O of the cardboard box B.

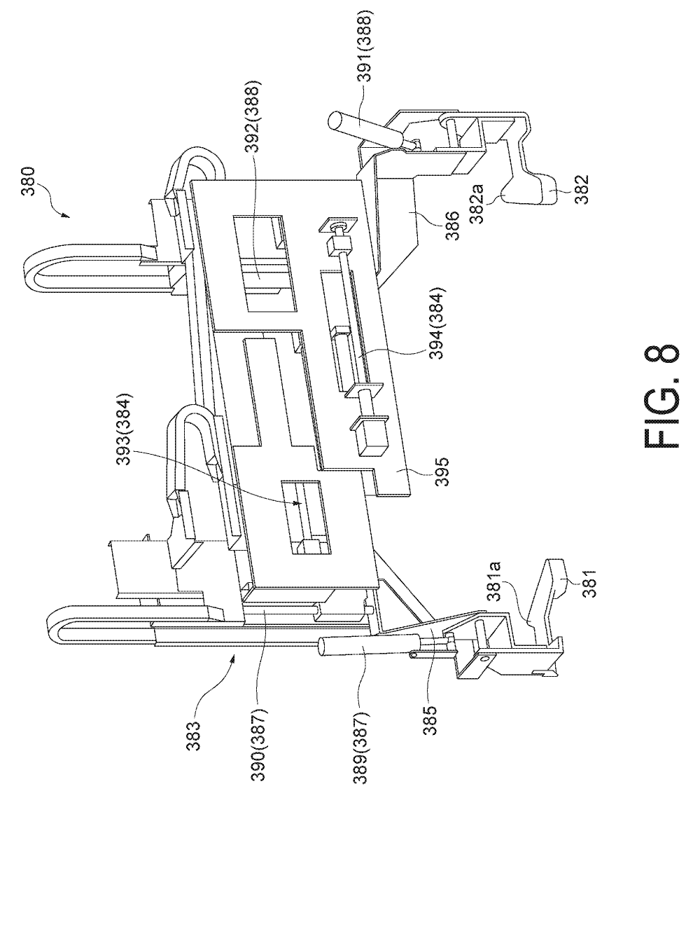

FIG. 8 is a perspective view illustrating a configuration of the folding unit 380. As illustrated in FIG. 8, the folding unit 380 includes a first abutting portion 381, a second abutting portion 382, a first mechanism 383, and a second mechanism 384.

The first abutting portion 381 abuts against the front flap Zfaa. The second abutting portion 382 abuts against the rear flap Zfab. The first abutting portion 381 and the second abutting portion 382 are spaced apart from each other in the transport direction of the transport unit 370. The first abutting portion 381 is disposed downstream of the second abutting portion 382 in the transport direction of the transport unit 370. In other words, the second abutting portion 382 is disposed upstream of the first abutting portion 381 in the transport direction of the transport unit 370.

The first abutting portion 381 is supported by a first support portion 385. The first abutting portion 381 is rotatably supported by the first support portion 385. The first abutting portion 381 rotates about an axis extending along the transport direction of the transport unit 370. In the first abutting portion 381, a convex portion 381a protruding downward is provided on the tip end side of an abutting section that abuts against the front flap Zfaa upon folding the front flap Zfaa during movement of the first abutting portion 381 by the second mechanism 384 (first drive mechanism 393).

The second abutting portion 382 is supported by a second support portion 386. The second abutting portion 382 is rotatably supported by the second support portion 386. The second abutting portion 382 rotates about an axis extending along the transport direction of the transport unit 370. In the second abutting portion 382, a convex portion 382a protruding downward is provided on the tip end side of an abutting section that abuts against the rear flap Zfab upon folding the rear flap Zfab during movement of the second abutting portion 382 by the second mechanism 384 (second drive mechanism 394).

The first mechanism 383 includes a first drive mechanism 387 and a second drive mechanism 388. The first drive mechanism 387 drives the first abutting portion 381. The first drive mechanism 387 makes the front flap Zfaa stand upright from below in conjunction with the operation of the first abutting portion 381. The first drive mechanism 387 includes a first drive unit 389 and a second drive unit 390.

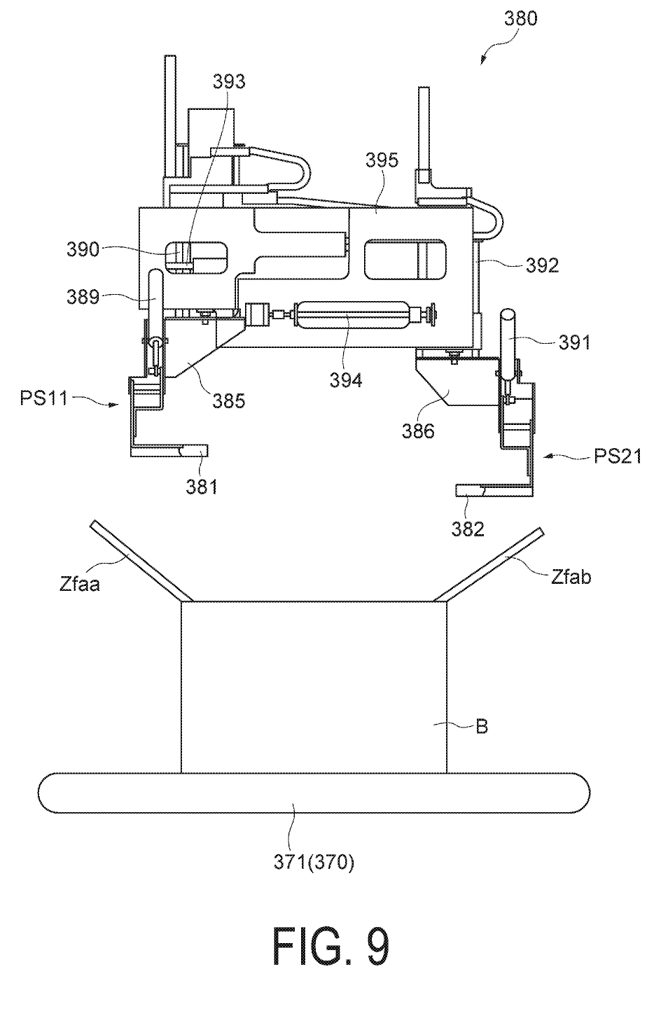

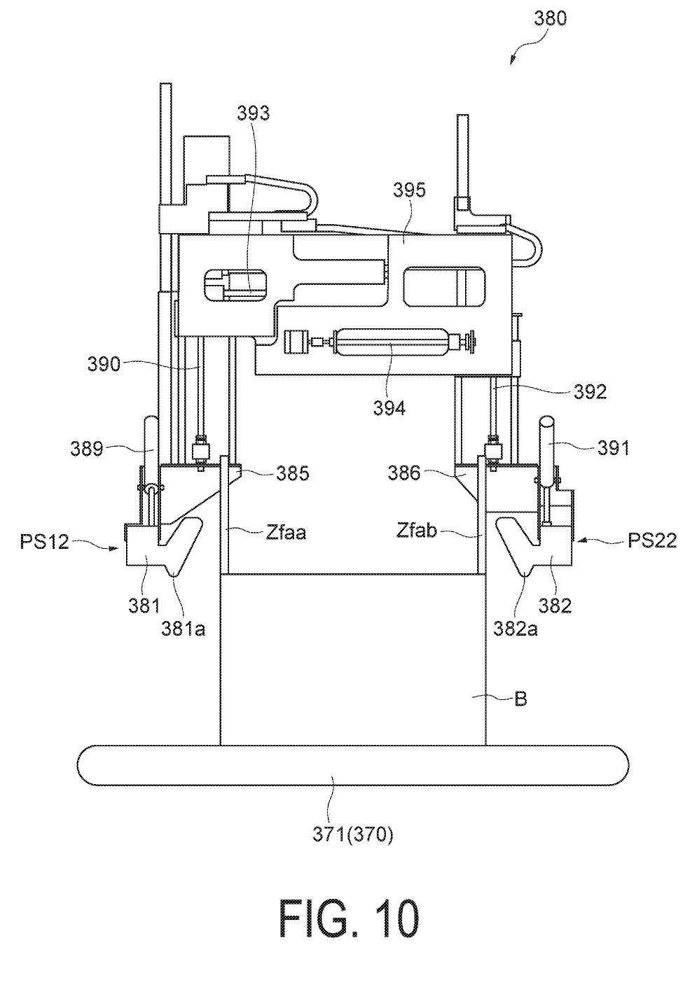

The first drive unit 389 rotates the first abutting portion 381. The first drive unit 389 is, for example, an air cylinder. The first drive unit 389 is attached to the first support portion 385. The first drive unit 389 rotates the first abutting portion 381 between a first position PS11 (see FIG. 9) and a second position PS12 (see FIG. 10). The second drive unit 390 moves the first support portion 385 in the vertical direction. The second drive unit 390 is, for example, an air cylinder. The second drive unit 390 is attached to a main body 395. The first support portion 385 is moved in the vertical direction by the second drive unit 390, and accordingly the first abutting portion 381 is moved in the vertical direction.

The second drive mechanism 388 drives the second abutting portion 382. The second drive mechanism 388 makes the rear flap Zfab stand upright from below in conjunction with the operation of the second abutting portion 382. The second drive mechanism 388 includes a first drive unit 391 and a second drive unit 392.

The first drive unit 391 rotates the second abutting portion 382. The first drive unit 391 is, for example, an air cylinder. The first drive unit 391 is attached to the second support portion 386. The first drive unit 391 rotates the second abutting portion 382 between a first position PS21 (see FIG. 9) and a second position PS22 (see FIG. 10). The second drive unit 392 moves the second support portion 386 in the vertical direction. The second drive unit 392 is, for example, an air cylinder. The second drive unit 392 is attached to the main body 395. The second support portion 386 is moved in the vertical direction by the second drive unit 392, and accordingly the second abutting portion 382 is moved in the vertical direction.

The second mechanism 384 includes a first drive mechanism 393 and a second drive mechanism 394. The first drive mechanism 393 moves the first abutting portion 381. The first drive mechanism 393 moves the first abutting portion 381 along the transport direction of the transport unit 370, thereby folding the front flap Zfaa standing upright toward the inside of the opening O. The first drive mechanism 393 moves the first support portion 385 so as to move the first abutting portion 381. The first drive mechanism 393 includes, for example, a ball screw and a motor. The first drive mechanism 393 is attached to the main body 395.

The second drive mechanism 394 moves the second abutting portion 382 along the transport direction of the transport unit 370, thereby folding the rear flap Zfab standing upright toward the inside of the opening O. The second drive mechanism 394 moves the second support portion 386 so as to move the second abutting portion 382. The second drive mechanism 394 includes, for example, a ball screw and a motor. The second drive mechanism 394 is attached to the main body 395.

As illustrated in FIG. 2, a tape applicator (sealing apparatus) 360 seals the front flap Zfaa, the rear flap Zfab, the left flap Zfal, and the right flap Zfar of the cardboard box B. The tape applicator 360 is installed near a discharge position of a transport path for the cardboard box B, and applies a tape to the cardboard box B before the cardboard box B reaches the discharge position. While applying the tape to the cardboard box B, the tape applicator 360 guides, along the transport direction, upper portions of both side surfaces of the cardboard box B in the width direction.

As illustrated in FIG. 1, a controller 40 controls the overall operation of the boxing system 1. The controller 40 is constituted by a central processing unit (CPU), a read only memory (ROM), a random access memory (RAM), and the like. A program for controlling the boxing system 1 and the like are stored in the ROM.

Next, the operation of the folding apparatus 340 will be described. FIGS. 9, 10 and 11 are diagrams for explaining the operation of the folding apparatus 340. In FIGS. 9, 10, and 11, the left flap Zfal and the right flap Zfar are not illustrated.

First, when the cardboard box B is carried onto the conveyor 371, the transport unit 370 transports the cardboard box B. As illustrated in FIG. 9, when the cardboard box B is positioned below the folding unit 380, the transport unit 370 stops the transport of the cardboard box B. Subsequently, the transport unit 370 operates the position adjustment mechanism 373 so as to adjust the position of the cardboard box B on the conveyor 371.

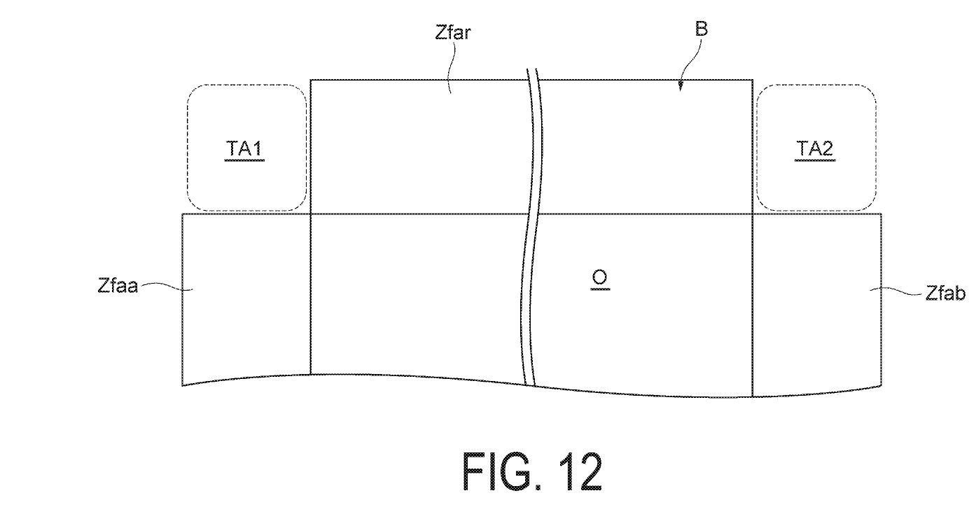

Then, as illustrated in FIG. 10, the second drive unit 390 in the first drive mechanism 387 of the first mechanism 383 of the folding unit 380 moves the first support portion 385 (first abutting portion 381) downward. As illustrated in FIG. 12, the first abutting portion 381 passes through a region TA1 formed by the front flap Zfaa and the right flap Zfar. The second drive unit 390 moves the first support portion 385 to a position at which the lower end of the convex portion 381a of the first abutting portion 381 is as high as or higher than the height position of the edge E of the cardboard box B.

As illustrated in FIG. 10, the second drive unit 392 in the second drive mechanism 388 of the first mechanism 383 of the folding unit 380 moves the second support portion 386 (second abutting portion 382) downward. As illustrated in FIG. 12, the second abutting portion 382 passes through a region TA2 formed by the rear flap Zfab and the right flap Zfar. As illustrated in FIG. 13, the second drive unit 392 moves the second support portion 386 to a position at which the lower end of the convex portion 382a of the second abutting portion 382 is as high as or higher than the height position of the edge E of the cardboard box B.

Subsequently, the first drive unit 389 in the first drive mechanism 387 of the first mechanism 383 of the folding unit 380 rotates the first abutting portion 381. The rotation of the first abutting portion 381 causes the first abutting portion 381 to enter below the front flap Zfaa. When the first abutting portion 381 further rotates, the first abutting portion 381 abuts against the front flap Zfaa, pushes up the front flap Zfaa, and makes the front flap Zfaa stand upright from below.

Further, the first drive unit 391 in the second drive mechanism 388 of the first mechanism 383 of the folding unit 380 rotates the second abutting portion 382. The rotation of the second abutting portion 382 causes the second abutting portion 382 to enter below the rear flap Zfab. When the second abutting portion 382 further rotates, the second abutting portion 382 abuts against the rear flap Zfab, pushes up the rear flap Zfab, and makes the rear flap Zfab stand upright from below.

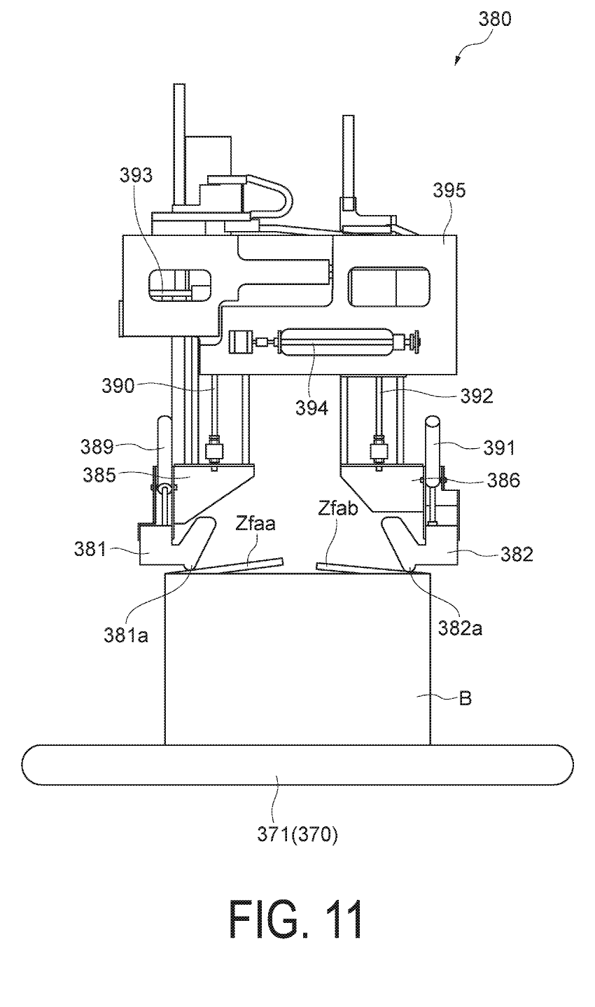

Subsequently, as illustrated in FIG. 11, the first drive mechanism 393 in the second mechanism 384 of the folding unit 380 moves the first abutting portion 381 toward the opening O of the cardboard box B. The second drive mechanism 394 in the second mechanism 384 of the folding unit 380 moves the second abutting portion 382 toward the opening O of the cardboard box B. The first abutting portion 381 and the second abutting portion 382 move in a direction in which the first abutting portion 381 and the second abutting portion 382 approach each other. As a result, the front flap Zfaa is folded toward the inside of the opening O, and the rear flap Zfab is folded toward the inside of the opening O. Note that the spacing between the first abutting portion 381 and the second abutting portion 382 at their standby positions (the positions illustrated in FIG. 9) can be set based on the size (length) of the cardboard box B.

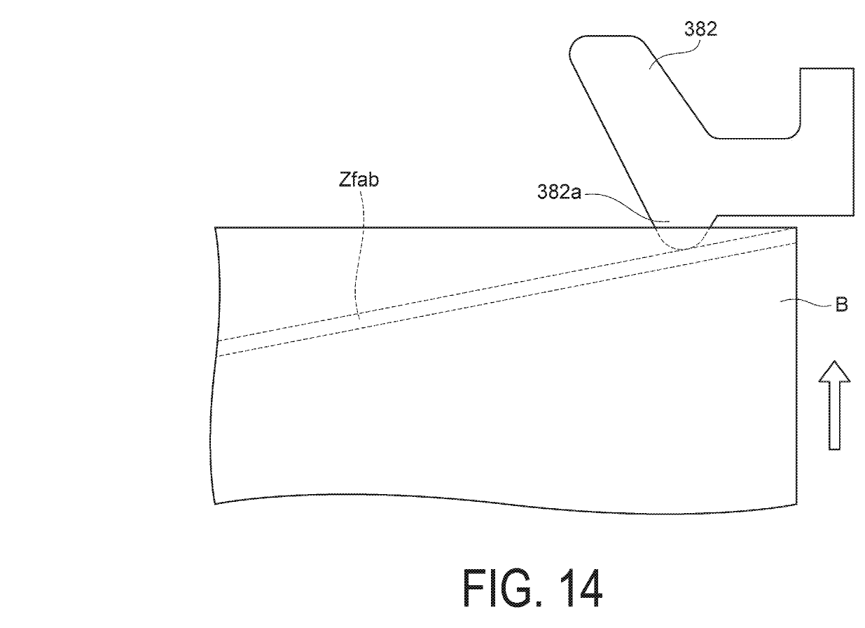

Subsequently, as illustrated in FIG. 14, the lifting mechanism 372 of the transport unit 370 raises the conveyor 371 and brings the cardboard box B closer to the folding unit 380. As a result, the front flap Zfaa is pressed against the first abutting portion 381, and the rear flap Zfab is pressed against the second abutting portion 382. Thus, the front flap Zfaa is further folded toward the inside of the opening O, and the rear flap Zfab is further folded toward the inside of the opening O.

Subsequently, the second drive unit 390 in the first drive mechanism 387 of the first mechanism 383 of the folding unit 380 moves the first support portion 385 (first abutting portion 381) upward. The second drive unit 392 in the second drive mechanism 388 of the first mechanism 383 of the folding unit 380 moves the second support portion 386 (second abutting portion 382) upward. In the folding unit 380, the first abutting portion 381 is positioned above the second abutting portion 382.

Finally, the transport unit 370 carries out the cardboard box B to the second conveyor 350. The transport unit 370 changes the position of the conveyor 371 by the lifting mechanism 372 such that the height position of the conveyor 371 is as high as the height position of the second conveyor 350, and carries out the cardboard box B to the second conveyor 350.

As described above, in the folding apparatus 340 according to the present embodiment, when the cardboard box B is positioned below the folding unit 380, the transport unit 370 stops the transport of the cardboard box B. In this configuration, the first mechanism 383 of the folding unit 380 drives the first abutting portion 381 and the second abutting portion 382, and makes the front flap Zfaa and the rear flap Zfab stand upright from below in conjunction with the operation of the first abutting portion 381 and the second abutting portion 382, and the second mechanism 384 moves the first abutting portion 381 and the second abutting portion 382 in the direction in which the first abutting portion 381 and the second abutting portion 382 approach each other, thereby folding the front flap Zfaa and rear flap Zfab standing upright toward the inside of the opening O. In this manner, in the folding apparatus 340, the front flap Zfaa and the rear flap Zfab can be folded in a state in which the cardboard box B is stopped. Therefore, the folding apparatus 340 can achieve space savings.

In the folding apparatus 340 according to the present embodiment, the transport unit 370 includes the lifting mechanism 372 that raises and lowers the cardboard box B in the vertical direction. The lifting mechanism 372 may bring the cardboard box B closer to the folding unit 380 by raising the cardboard box B. In this configuration, in addition to folding the front flap Zfaa and the rear flap Zfab using the second mechanism 384, by bringing the cardboard box B closer to the first abutting portion 381 and the second abutting portion 382 using the lifting mechanism 372, the front flap Zfaa and the rear flap Zfab can be more reliably folded in a short time period. Since the height position of the conveyor 371 can be changed by the lifting mechanism 372, the height position can be adjusted to the height position of a carry-out destination (second conveyor 350) of the cardboard box B.

In the folding apparatus 340 according to the present embodiment, the first abutting portion 381 is disposed downstream of the second abutting portion 382 in the transport direction in the transport unit 370. The folding unit 380 positions the first abutting portion 381 above the second abutting portion 382 when the transport unit 370 transports the cardboard box B after the front flap Zfaa and the rear flap Zfab are folded. In this configuration, when the cardboard box B is transported (discharged) by the transport unit 370, it is possible to prevent the first abutting portion 381 from coming into contact with the front flap Zfaa and the rear flap Zfab.

Although an embodiment of the present disclosure has been described above, the present disclosure is not necessarily limited to the above-described embodiment, and various modifications can be made without departing from the gist of the present disclosure.

In the embodiment described above, an example is described of a mode in which the first mechanism 383 makes the front flap Zfaa and the rear flap Zfab stand upright from below by rotating the first abutting portion 381 and the second abutting portion 382, respectively. However, the operation of the first abutting portion 381 and the second abutting portion 382 to respectively make the front flap Zfaa and the rear flap Zfab stand upright is not limited to the rotational movement, and may be movement in the vertical direction or the like.

In the embodiment described above, an example is described of a mode in which the folding unit 380 positions the first abutting portion 381 above the second abutting portion 382 when the transport unit 370 transports the cardboard box B after the front flap Zfaa and the rear flap Zfab are folded. However, the height positions of the first abutting portion 381 and the second abutting portion 382 may be the same, when the transport unit 370 transports the cardboard box B after the front flap Zfaa and the rear flap Zfab are folded.

In the embodiment described above, an example is described of a mode in which the convex portion 381a is provided in the first abutting portion 381. However, the convex portion 381a may not necessarily be provided. Similarly, the convex portion 382a may not necessarily be provided in the second abutting portion 382.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

1. A folding apparatus comprising:
a transport unit configured to transport a cardboard box in a transport direction that is substantially horizontal; and
a folding unit disposed above the transport unit, the folding unit being configured to fold, among a plurality of flaps provided at an edge of an opening of the cardboard box, a pair of the flaps into an inside of the opening of the cardboard box, the pair of the flaps extending in a direction intersecting the transport direction in a horizontal direction, wherein
the transport unit stops transport of the cardboard box when the cardboard box is positioned below the folding unit, and
the folding unit includes
a first abutting portion configured to abut against one of the pair of the flaps, and a second abutting portion configured to abut against an other of the pair of the flaps,
a first mechanism configured to drive the first abutting portion and the second abutting portion and make the pair of the flaps stand upright from below respectively in conjunction with an operation of the first abutting portion and the second abutting portion, and
a second mechanism configured to fold the pair of the flaps standing upright toward an inside of the opening by moving the first abutting portion and the second abutting portion along the transport direction.

2. The folding apparatus according to claim 1, wherein
the transport unit includes a lifting mechanism configured to raise and lower the cardboard box in a vertical direction, and
the lifting mechanism brings the cardboard box closer to the folding unit by raising the cardboard box.

3. The folding apparatus according to claim 1, wherein
the first abutting portion is disposed downstream of the second abutting portion in the transport direction of the transport unit, and
the folding unit positions the first abutting portion above the second abutting portion when the transport unit transports the cardboard box after the pair of the flaps are folded.

4. The folding apparatus according to claim 1, wherein
in each of the first abutting portion and the second abutting portion, a convex portion protruding downward is provided on a tip end side of an abutting section that abuts against a corresponding one of the flaps upon folding the corresponding flap during movement of the first abutting portion and the second abutting portion by the second mechanism.

5. A box sealing apparatus comprising:
the folding apparatus according to claim 1; and
a sealing apparatus configured to seal the flaps of the cardboard box in which the pair of the flaps have been folded by the folding apparatus.
